(19) United States
(12) Patent Application Publication
(10) Pub. No.: US 2008/0188588 A1
(43) Pub. Date: Aug. 7, 2008

(54) Waterborne Latex Traffic Paint Compositions Including a Renewable Resource-Based Binder

(76) Inventors: Carl J. Sullivan, Chapel Hill, NC (US); Eric Dumain, Hillsborough, NC (US)

Correspondence Address: MYERS BIGEL SIBLEY & SAJOVEC, PO BOX 37428, RALEIGH, NC, 27627, US

(21) Appl. No.: 11/955,815

(22) Filed: Dec. 13, 2007

Related U.S. Application Data
(60) Provisional application No. 60/870,186, filed on Dec. 15, 2006.

(51) Int. Cl. F21V 7/22; C08F 12/08

(52) U.S. Cl. 523/172; 526/346

(57) ABSTRACT

Provided according to some embodiments of the invention are traffic paint compositions that include a) a high-solids aqueous emulsion of an alkyd resin derived from a natural oil and a surfactant system including a nonionic surfactant and an anionic surfactant; and b) a pigment. Traffic paint compositions according to embodiments of the invention may meet the federal standards for traffic paint as set forth in Federal Specification TT-P-1952B. Methods of applying a traffic paint composition according to an embodiment of the invention are also provided.

### CROSS-REFERENCE TO RELATED APPLICATIONS

This application claims the benefit of U.S. Provisional Patent Application No. 60/870,186, filed Dec. 15, 2006, the disclosure of which is herein incorporated by reference in its entirety.

### FIELD OF THE INVENTION

The present invention relates to traffic paint compositions, and more particularly, to waterborne latex traffic paints.

### BACKGROUND OF THE INVENTION

Parking lot zone marking and road stripping traffic paints have traditionally been formulated with solvent-borne alkyds. However, such solvent-borne alkyds may not meet the restrictive environmental targets for reduced solvent emissions. As a result, waterborne traffic paints have been investigated, particularly waterborne acrylic latexes. See, e.g., U.S. Pat. Nos. 5,861,188 and 5,824,735. However, acrylic and vinyl acrylic polymers are typically derived from acrylic monomers, styrene monomers and other monomers derived from non-renewable petroleum or natural gas feedstocks.

There is currently a need in the industry for products derived from renewable resources in order to reduce dependency on petroleum feedstocks. This need is exemplified by the United States Security and Rural Investment Act of 2002, which mandates that governmental procurement agencies, such as federal and state Departments of Transportation that specify or purchase traffic paint, must consider buying products based on renewable resources, if they meet performance requirements and are comparably priced. Thus, while the waterborne acrylic latexes may comply with the volatile organic compounds (VOC) restrictions, they may fail to comply with the government mandate for products derived from renewable resources. Hence, there is a need for traffic paints that meet VOC requirements and performance targets, but also include a resinous binder that is derived from renewable resources.

Alkyd resins are typically derived from vegetable or animal oils and, as such, are based on bio-renewable resources. However, as described above, solvent-borne alkyds may not comply with VOC requirements. Waterborne alkyd dispersions are known in the art and arc commercially available. For example, U.S. Pat. No. 3,442,835 describes alkyd emulsions that incorporate polyethylene glycol (PEG) into the alkyd polymer chain and include neutralized residual acid groups, in order to enable water dispersion. While such dispersion techniques may be effective, the dispersions, and products formed therefrom, may have an undesirably short shelf-life because the agent used to neutralize the acid groups may catalyze the hydrolysis of the alkyd binder during storage. In addition, the polyether linkages, such as from the PEG, in the alkyd typically exhibit poor exterior stability due to photo-oxidative degradation. Hence, such products may not be suitable for exterior applications that require long service life.

Alkyd dispersions are also discussed in U.S. Pat. No. 6,780,910, which describes an alkyd latex created by an emulsion inversion process that includes forming an alkyd resin, neutralizing residual acid groups, adding surfactant and adding water such that an “oil in water” emulsion is formed. The alkyd dispersions thus formed are described as being useful in wood stains and common architectural paints. However, as with the alkyd dispersions in U.S. Pat. No. 3,442,835, the neutralization of the alkyd acid groups may lead to problems with stability of the alkyd during storage.

U.S. Pat. No. 6,787,599 describes reacting a hydroxy-functional alkyd emulsion or an alkyd urethane emulsion with a water-dispersible polyisocyanate in a two-component coating formulation. While such compositions may lead to durable coatings, two-component formulations may be difficult to apply in the field, and so may be less desirable than one-component formulations.

To date, there are no known waterborne traffic paint compositions that include an alkyd binder due to the deficiencies of current waterborne alkyd dispersion technology. Therefore, there is a need for low VOC traffic paint compositions that meet performance standards of traffic paint and road-stripping applications, and that further include, at least in part, bio-renewable resources.

### SUMMARY OF THE INVENTION

Provided according to some embodiments of the invention are traffic paint compositions that include a) a high-solids aqueous emulsion of an alkyd resin derived from a natural oil and a surfactant system including a nonionic surfactant and an anionic surfactant; and b) a pigment.

In some embodiments of the invention, the alkyd resin includes an acrylic modified alkyd resin. In some embodiments of the invention, the alkyd resin includes a styrene/acrylic modified resin.

In some embodiments, the nonionic surfactant includes a polyalkylene glycol ether. In some embodiments, the anionic surfactant includes a sodium alkyl aryl sulphonate, and in some embodiments, the anionic surfactant includes sodium dodecyl benzene sulfonate.

In addition, in some embodiments of the present invention, traffic paint compositions include less than 100 g/l of volatile organic compounds (VOC).

In addition, in some embodiments of the present invention, traffic paint compositions meet the federal standards for traffic paint as set forth in Federal Specification TT-P-1952B.

Furthermore, methods according to some embodiments of the invention may include applying a traffic paint composition according to an embodiment of the invention to a surface such that a solid traffic paint is formed on the surface. In some embodiments, the surface includes asphalt and/or concrete, and in some embodiments, the surface is a road.

### DETAILED DESCRIPTION OF EMBODIMENTS OF THE INVENTION

The invention is described more fully hereinafter. This invention may, however, be embodied in many different foams and should not be construed as limited to the embodiments set forth herein. Rather, these embodiments are provided so that this disclosure will be thorough and complete, and will fully convey the scope of the invention to those skilled in the art.

The terminology used herein is for the purpose of describing particular embodiments only and is not intended to be limiting of the invention. As used herein, the singular forms “a”, “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein. Furthermore, any patent reference cited herein is hereby incorporated by reference in its entirety.

As used herein:

The term “alkyd resin” refers to a resin that includes a polyester derived from the reaction of an alcohol and an acid or an acid anhydride. In some embodiments, the alkyd resin includes an alkyd that is derived from at least one anhydride and at least one polyol, and is modified with an unsaturated fatty acid. Suitable alkyd resins include those available from Reichhold Inc. under the tradename BECKOSOL® AQ. The tend “short oil alkyd” refers to an alkyd having an oil content of less than about 40%. The term “medium oil alkyd” refers to an alkyd having an oil content of between about 40 and 55%. The term “long oil alkyd” refers to an alkyd having an oil content of greater than about 55%.

The term “styrene/acrylic modified alkyd resin” refers to a resin that includes an alkyd derived by polymerizing styrene and acrylic monomers in the presence of an alkyd such that at least some grafting occurs. The term also refers to styrene and acrylic polymer made separately and then blended with an alkyd that affords compatibility. Likewise, the term “acrylic modified alkyd resin” refers to analagous compositions wherein styrene is not present. It is understood that a wide range of acrylic monomers can be used to form these alkyd resins and that for the styrene/acrylic modified alkyd resin, a substituted styrene may be used, e.g., vinyl toluene, alpha methyl styrene or any other similar monomer capable of free radical polymerization.

The term “high-solids aqueous emulsion” refers to an emulsion having a solids content of about 40% or more.

The term “low VOC” refers to compositions that include volatile organic compounds at a concentration of less than 250 grams per liter and, in some embodiments, less than 100 grams per liter.

The tern “natural oil” refers to any triglyceride derived from a renewable resource, such as plant material. Exemplary natural oils include soybean oil, palm oil, sunflower seed oil, linseed oil, and the like.

According to some embodiments of the present invention, traffic paint compositions include a) a high-solids aqueous emulsion including an alkyd resin derived from a natural oil and a surfactant system including a nonionic surfactant and an anionic surfactant; and b) a pigment.

In some embodiments of the invention, the alkyd resin includes an acrylic modified alkyd resin. In some embodiments of the invention, the alkyd resin includes a styrene/acrylic modified resin.

Any suitable nonionic surfactant may be used, such as polyoxyalkylene alkyl ethers, polyoxyalkylene alkylphenyl ethers, polyoxyalkylene fatty acid esters, polyoxyethylene-polyoxypropylene alkyl ethers, polyoxyalkylene alkylamines, glycerol fatty acid esters, higher fatty acid alkanolamides, alkylglycosides, alkylglucosamides, alkylamine oxides, and the like, and mixtures thereof. In particular embodiments, the nonionic surfactant is a polyalkylene glycol ether.

Any suitable anionic surfactant may be used, such as a sodium alkyl aryl sulfonates, alkyl sulphonates, alkylpolyether sulphates, alkyl sulfates, fatty acid soaps, salts of hydrox-, hydroperoxy-, polyhydroxy-, epoxy-fatty acids, salts of mono- and polycarboxylic acids, alkyl phosphates, alkyl phosphonates, sodium-dialkyl sufosuccinate, n-alkyl ethoxylated sulfates, perfluorocarboxylic acids, fluoroacliphatic phosphonates, fluoroaliphatic sulphates, and mixtures thereof. In particular embodiments, the anionic surfactant includes sodium dodecyl benzene sulfonate.

Any suitable pigments may be used, including, but not limited to, bright pigments such as aluminum powder, copper powder, nickel powder, stainless steel powder, chromium powder, micaceous iron oxide, titanium dioxide-coated mica powder, iron oxide-coated mica powder and bright graphite; organic red pigments such as Pink EB, azo- and quinacridone-derived pigments; organic blue pigments such as cyanin blue and cyanin green; organic yellow pigments such as benzimidazolone-, isoindolin- and quinophthalone-derived pigments; inorganic colored pigments such as titanium white, titanium yellow, iron red, carbon black, chrome yellow, iron oxide, various calcined pigments, and mixtures thereof.

Any suitable alkyd resin derived from a natural oil may be used. However, in some embodiments, the alkyd resin is derived from soybean oil.

The traffic paint compositions may further include other suitable components, including, but not limited to, thickeners, rheology modifiers, dispersants, defoamers, biocides, and the like.

The traffic paint compositions according to some embodiments of the present invention are in compliance with federal mandates for traffic paint compositions, including having a low VOC content (less than 250 g/l). A federal mandate for traffic paint is described in Federal Specification TT-P-1952B, as summarized in Table 1 below:

TABLE 1

| Property Test | Requirement for TT-P-1952B |
|---|---|
| Condition in Container | No biological growth, corrosion of container, |
| | Livering or hard settling |
| Appearance | Film which is smooth, uniform, free from grit, |
| | undispersed particles, craters and pinholes |
| Oven Stability | 70-80 Kreb Unit Viscosity after two weeks. |
| | (52° C.; 2 weeks). |
| Flexibility | Pass ⅛ mandrel bend (no crack, chip or flake) |
| Water resistance | No deterioration - Shall not soften, blister, |
| | wrinkle, lose adhesion or change color |
| Freeze-thaw stability | Pass 5 cycles - 65 to 95 Kreb Units Viscosity |
| Color | Match within ΔE of 6 CIELAB units |
| Directional Reflectance | >92% white |
| Abrasion Resistance | >65 liters sand to break through |
| Accelerated Weathering | In conformance with color, reflectance & |
| | yellow color match tests; scrub |
| | resistance >500 cycles |
| Scrub resistance | >400 cycles |
| VOC | <250 g/l |
| Consistency | 70-90 KU |
| Total Solids, wt % | >50% |
| Dry opacity | >0.92 in white |
| No Track Time | <75 minutes |
| Fineness of dispersion | 3 Hegman minimum |
| Bleeding ratio | 0.95 minimum |

Traffic paint compositions according to embodiments of the present invention may be applied to any suitable surface, including concrete, asphalt, and the like. In some embodiments, the surface is a road, such as a road (e.g., street or highway) used for motor vehicles. According to some embodiments of the invention, the compositions may be applied to a substrate by any method known to those of skill in the art, such as spraying, rolling, knife-coating, pouring, brushing or dipping. According to some embodiments, methods of applying the traffic paint may include applying a traffic paint composition according to an embodiment of the invention to a surface. In some embodiments such methods may result in the formation a solid traffic paint on the surface.

The present invention will now be described in more detail with reference to the following examples. However, these examples are given for the purpose of illustration and are not to be construed as limiting the scope of the invention.

### EXAMPLES

### Alkyd Latex Example

An alkyd resin was synthesized utilizing 1,889.7 lbs soybean oil 1249.53 glycerine (high gravity, 99%), 2,209.63 lbs phthalic anhydride, using 4.722 lbs lithium neodecanoate (2% lithium) as a catalyst, using conventional esterification techniques. Upon achieving the target acid number of less than 10 mg KOH/g resin, the resin was cooled to between 50° C. and 100° C. and 508.53 lbs ATLAS G-5000 surfactant and 33.563 lbs of diethanolamine neutralizer were added to the alkyd resin. Subsequently, water was slowly added with constant agitation until the desired solids level of 55% was achieved.

### Traffic Paint Example 1

For the first component, 253.95 lbs water, 1.20 lbs Natrosol 250MR, 1.20 lbs Attagel 50, 9.60 lbs Colloid 226, 2.0 lbs Rhodaline 643, 0.7 lbs Kathon LX, 3.2 lbs Triton CF10, 99.98 lbs TiO₂ (CR800), 699.86 lbs Duramite (Hi OA) and 6.0 lbs of RM8W were ground to a 4 hegman. For the second component, 289.94 lbs of the short oil alkyd latex of Alkyd Latex Example 1, 2.70 lbs Cobalt Hydro II, 0.35 lbs Dri-RX and 3.5 lbs 12% ZR Hydro CEM were mixed for 5 minutes. The first component was then mixed with the second component to provide the traffic paint composition.

Properties of this traffic paint are Volume Solids of 52.9%, Density of 13.74 lbs/gallon, VOC of 8.3 grams/liter and viscosity of 99 Krebs Units. Condition in the can was good, appearance of film was good, oven stability testing showed change of −2 Kreb Units after 2 weeks at 50 C (dropped to 97 Kreb Units) and a No Track Dry Time of <60 minutes. The resin binder of this particular traffic paint has a renewable resource content (RRC) of 58%. Therefore, this composition meets the critical parameters of having binder based upon renewable resource, having less than 250 grams/liter VOC and a No Track Time of less than 75 minutes.

### Traffic Paint Example 2 (Comparative)

### All Acrylic Latex

For the first component, 432.2 lbs Synthemul® 97-932 acrylic latex, 7.35 lbs Colloid 226, 2.87 lbs Triton CF10, 1.01 lbs Rhodaline 643 water, 100.65 Titanium Dioxide (CR800), 791.7 lbs Duramite HiOA, 30.20 lbs methanol, 23.96 lbs Texanol, 2.01 lbs Rhodaline 643 and 35.83 lbs water were ground to a 4 hegman.

Properties of this traffic paint are Volume Solids of 63.9%, Density of 14.28 lbs/gallon, VOC of 90 grams/liter and viscosity of 82 Krebs Units. Condition in the can was good, appearance of film was good, oven stability testing showed a decrease of 2 Kreb Units alter 2 weeks at 50 C and a No Track Dry Time of 50 minutes. However, the acrylic resin binder of this particular traffic paint has a RRC of 0%. While it can meet the VOC and Critical No Track Time requirements of Specification TT-P-1952B, this traffic paint binder has zero renewable resource content and thereby will not comply with the United States Security and Rural Investment Act of 2002.

### Traffic Paint Example 3

For the first component, 157.67 lbs Bentone EW Solution (2%), 9.85 lbs BYK 190, 0.99 lbs Rhodaline 643, 0.59 Kathon LX, 1.01 lbs Triton CF10, 98.54 lbs titanium dioxide (CR800), 689.79 lbs Duramite, 29.56 lbs water were ground to a 4 hegman. For the second component, 360.15 lbs BECKOSOL® AQ 100 (long oil alkyd latex, 53% RRC on solids), 3.36 lbs Cobalt Hydrocure II, 4.30 lbs Zr HydroCEM, 0.25 lbs Dri-RX were mixed for 5 minutes. The first component was then mixed with the second component, and then 0.93 lbs of Rhodaline 643 and 1.74 lbs RM8W were added to the mixture to provide the traffic paint composition. Properties are provided in Table 2.

### Traffic Paint Example 4

For the first component, 157.67 lbs Bentone EW Solution (2%), 9.85 lbs BYK 190, 0.99 lbs Rhodaline 643, 0.59 Kathon LX, 1.01 lbs Triton CF10, 98.54 lbs titanium dioxide (CR800), 689.79 lbs Duramite, 29.56 lbs water were ground to a 4 hegman. For the second component, 360.15 lbs BECKOSOL® AQ 200 (medium oil alkyd latex, 47% RRC on solids), 3.36 lbs Cobalt Hydrocure II, 4.30 lbs Zr HydroCEM, were mixed for 5 minutes. The first component was then mixed with the second component, and then 0.93 lbs of Rhodaline 643 and 1.74 lbs RM8W were added to the mixture to provide the traffic paint composition. Properties are provided in Table 2.

### Traffic Paint Example 5

For the first component, 157.67 lbs Bentone EW Solution (2%), 9.85 lbs BYK 190, 0.99 lbs Rhodaline 643, 0.59 Kathon LX, 1.01 lbs Triton CF10, 98.54 lbs titanium dioxide (CR800), 689.79 lbs Duramite, 14.77 lbs water were ground to a 4 hegman. For the second component, 360.15 lbs BECKOSOL® AQ 310 (short oil alkyd latex, 40% RRC on solids), 3.06 lbs Cobalt Hydrocure II, 3.94 lbs Zr HydroCEM, and 0.46 lbs Dri-RX IF were mixed for 5 minutes. The first component was then mixed with the second component, and then 0.93 lbs of Rhodaline 643 and 1.74 lbs RM8W were added to the mixture to provide the traffic paint composition. Properties are provided in Table 2.

### Traffic Paint Example 6

For the first component, 157.67 lbs Bentone EW Solution (2%), 9.85 lbs BYK 190, 0.99 lbs Rhodaline 643, 0.59 Kathon LX, 1.01 lbs Triton CF10, 98.54 lbs titanium dioxide (CR800), 689.79 lbs Duramite, 29.56 lbs water were ground to a 4 hegman. For the second component, 360.15 lbs BECKOSOL® AQ 300 (short oil alkyd latex, 53% RRC on solids), 3.36 lbs Cobalt Hydrocure II, 4.30 lbs Zr HydroCEM were mixed for 5 minutes. The first component was then mixed with the second component, and then 0.93 lbs of Rhodaline 643 and 1.74 lbs RM8W were added to the mixture to provide the traffic paint composition. Properties are provided in Table 2.

### Traffic Paint Example 7

For the first component, 157.67 lbs Bentone EW Solution (2%), 9.85 lbs BYK 190, 0.99 lbs Rhodaline 643, 0.59 Kathon LX, 1.01 lbs Triton CF10, 98.54 lbs titanium dioxide (CR800), 689.79 lbs Duramite, 23.87 lbs water were ground to a 4 hegman. For the second component, 360.15 lbs BECKOSOL® AQ 530 (styrene/acrylic modified oil alkyd latex, 42% RRC on solids), 3.20 lbs Cobalt Hydrocure II, 4.10 lbs Zr HydroCEM were mixed for 5 minutes. The first component was then mixed with the second component, and then 0.93 lbs of Rhodaline 643 and 1.74 lbs RM8W were added to the mixture to provide the traffic paint composition. Properties are provided in Table 2.

### Traffic Paint Example 8

For the first component, 157.67 lbs Bentone EW Solution (2%), 9.85 lbs BYK 190, 0.99 lbs Rhodaline 643, 0.59 Kathon LX 1.01 lbs Triton CF10, 98.54 lbs titanium dioxide (CR800) 689.79 lbs Duramite, 23.87 lbs water were ground to a 4 hegman. For the second component, 360.15 lbs BECKOSOL® AQ 520 (styrene/acrylic modified alkyd latex, 38% RRC on solids), 3.20 lbs Cobalt Hydrocure II, 4.10 lbs Zr HydroCEM were mixed for 5 minutes. The first component was then mixed with the second component, and then 0.93 lbs of Rhodaline 643 and 1.74 lbs R148W were added to the mixture to provide the traffic paint composition. Properties are provided in Table 2.

### Traffic Paint Example 9 (Comparative)

### All Acrylic Latex

Sherwin Williams' SetFast Acrylic—Code TM 226. Complies with Specification TT-P-1952B. Properties are provided in Table 3.

### Traffic Paint Example 10 (Comparative)

### All Acrylic Latex

Sherwin Williams' SetFast Acrylic—Code TM 2160 Properties are provided in Table 3.

### Traffic Paint Example 11 (Comparative)

### Solvent Borne Alkyd

Promar Alkyd Fast Dry—Code TM 5494 Properties are provided in Table 3.

### Traffic Paint Example 12 (Comparative)

### Acrylic Latex Zone Marking Paint, Blue

Valspar Zone Marking Paint, Blue. Properties are provided in Table 3.

TABLE 2
TRAFFIC PAINT PROPERTIES

| | TT-P-1952B | Example | Example | Example | Example | Example | Example |
|---|---|---|---|---|---|---|---|
| Paint Property | Value Desired | 3 | 4 | 5 | 6 | 7 | 8 |
| Density | n.a. | 13.57 | 13.57 | 13.67 | 13.57 | 13.61 | 13.60 |
| (lbs/gal) | | | | | | | |
| Weight % | >50% | 73.6% | 73.6% | 73.38% | 73.64% | 73.42% | 73.41% |
| Solids | | | | | | | |
| Vol. % Solids | n.a. | 56.78% | 56.84% | 56.10% | 56.84% | 56.37% | 56.34% |
| Viscosity | 70-90 | 84.5 | 84.0 | 82.3 | 87.0 | 83.0 | 85.0 |
| (KU) | | | | | | | |
| Condition in | Good | Good | Good | Good | Good | Good | Good |
| Can | | | | | | | |
| Film | Smooth | Smooth | Smooth | Smooth | Smooth | Smooth | Smooth |
| Appearance | | | | | | | |
| Flexibility | Pass ⅛″ Bend | Fail | Fail | Pass | Fail | Pass | Pass |
| Abrasion | >65 L to | Not | Not | 155 L | Not | Not | 160 L |
| (falling sand) | breakthrough | tested | tested | | tested | tested | |
| No Track | <75 | 51 | 53 | 25 | 49 | 30 | 28 |
| Time (min.) | | | | | | | |
| Binder RRC | n.a. | 53% | 47% | 40% | 53% | 42% | 38% |
| VOC (g/l) | <250 | 9.10 | 8.7 | 8.9 | 8.7 | 8.4 | 8.4 |

TABLE 3
TRAFFIC PAINT PROPERTIES - COMPARATIVE EXAMPLES

| | TT-P-1952B | Example | Example | Example | Example |
|---|---|---|---|---|---|
| Paint Property | Value Desired | 9 | 10 | 11 | 12 |
| Density | n.a. | Not | Not | Not | Not |
| (lbs/gal) | | Tested | Tested | Tested | Tested |
| Weight % | >50% | Not | Not | Not | Not |
| Solids | | Tested | Tested | Tested | Tested |
| Vol. % Solids | n.a. | 41% | 45% | Not | Not |
| | | | | Tested | Tested |
| Viscosity | 70-90 | 83.3 | 80.3 | 73.6 | 94.2 |
| (KU) | | | | | |
| Condition in | Good | Good | Good | Good | Good |
| Can | | | | | |
| Film | Smooth | Smooth | Smooth | Smooth | Smooth |
| Appearance | | | | | |
| Flexibility | Pass ⅛″ | Pass | Pass | Fail | Pass |
| | Bend | | | | |
| Abrasion | >65 L to | >200 L | >200 L | 70 L | Not |
| (falling sand) | breakthrough | | | | tested |
| No Track | <75 minutes | 24 | 35 | 7.5 | 47 |
| Time | | | | | |
| Binder RRC | n.a. | 0 | 0 | @ 50% | 0 |
| VOC (g/l) | <250 | 88 | 91 | 382 | <100 |

### Traffic Paint Example 13

To traffic paint of Example 3 was added acetone to the level of 6% of total weight. The critically important No Track Time was measured and found to be 34 minutes versus 51 minutes without the acetone.

### Traffic Paint Example 14

To traffic paint of Example 6 was added VM&P Naptha to the level of 6% of total weight. The No Track Time was measured and found to be 29 minutes versus 49 minutes without the VM&P Naptha.

Although selected embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A traffic paint composition comprising
a) a high-solids aqueous emulsion of an alkyd resin derived from a natural oil and a surfactant system comprising a nonionic surfactant and an anionic surfactant; and
b) a pigment.

2. The traffic paint composition of claim 1, wherein the alkyd resin derived from a natural oil comprises a styrene/acrylic modified alkyd resin.

3. The traffic paint composition of claim 1, wherein the alkyd resin derived from a natural oil comprises an acrylic modified alkyd resin.

4. The traffic paint composition of claim 1, wherein the nonionic surfactant comprises a polyalkylene glycol ether.

5. The traffic paint composition of claim 1, wherein the anionic surfactant comprises a sodium alkyl aryl sulfonate.

6. The traffic paint composition of claim 5, wherein the anionic surfactant comprises sodium dodecyl benzene sulfonate.

7. The traffic paint composition of claim 1 that meets the federal standards for traffic paint as set forth in Federal Specification TT-P-1952B.

8. The traffic paint composition of claim 1, comprising less than 100 g/l of volatile organic compounds (VOC).

9. A method of applying the traffic paint composition of claim 1, comprising applying the traffic paint composition to a surface such that the traffic paint composition forms a solid traffic paint on the surface.

10. The method of claim 9, wherein the surface comprises concrete and/or asphalt.

11. The method of claim 10, wherein the surface is a road.
